(19) United States
(12) Patent Application Publication
(10) Pub. No.: US 2025/0149546 A1
(43) Pub. Date: May 8, 2025

(54) CO-SPUTTERED SILICON-METAL COMPOSITE LAYER FOR ANODE ELECTRODES OF ALL-SOLID-STATE BATTERY CELLS

(71) Applicant: GM GLOBAL TECHNOLOGY OPERATIONS LLC, Detroit, MI (US)

(72) Inventors: Zhe LI, Shanghai (CN); Qili Su, Shanghai (CN); Yong Lu, Shanghai (CN); Meiyuan Wu, Shanghai (CN); Haijing Liu, Shanghai (CN)

(21) Appl. No.: 18/654,585

(22) Filed: May 3, 2024

(30) Foreign Application Priority Data
Nov. 3, 2023 (CN) 2023114587867

(51) Int. Cl. H01M 4/36; H01M 4/02; H01M 4/04; H01M 4/1395; H01M 4/38; H01M 10/0562

(52) U.S. Cl. CPC H01M 4/364; H01M 4/1395; H01M 4/386; H01M 10/0562; H01M 2004/021; H01M 2004/027; H01M 2004/028; H01M 4/0426; H01M 2300/008

(57) ABSTRACT

A battery cell includes C cathode electrodes including a cathode active material layer arranged on a cathode current collector, A anode electrodes including an anode active material layer arranged on an anode current collector, and S separators, where A, C and S are integers greater than one. The anode active material layer comprises silicon and a metal that are co-sputtered. The metal is different than the silicon.

### CROSS-REFERENCE TO RELATED APPLICATIONS

This application claims the benefit of Chinese Patent Application No. 202311458786.7 filed on Nov. 3, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes including a co-sputtered silicon-metal composite layer for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell includes C cathode electrodes including a cathode active material layer arranged on a cathode current collector, A anode electrodes including an anode active material layer arranged on an anode current collector, and S separators, where A, C and S are integers greater than one. The anode active material layer comprises silicon and a metal that are co-sputtered. The metal is different than the silicon.

In other features, the metal is selected from a group consisting of titanium (Ti), zirconium (Zr), a Group 4 (IVb) metal, vanadium (V), niobium (Nb), and a Group 5 (Vb) metal.

In other features, the metal comprises titanium. The silicon comprises 30 at % to 99.5 at % of the anode active material layer, and the titanium comprises 0.5 at % to 70 at % of the anode active material layer. The anode current collector has a surface roughness in a range from 2 μm to 12 μm. The anode active material layer includes a plurality of columns. The plurality of columns have a height in a range from 1.0 μm to 80 μm and width in a range from 1.0 μm to 80 μm.

In other features, the anode active material layer is planar and has a thickness in a range from 2 μm to 80 μm. The anode active material layer is planar and includes a plurality of convex portions. A thickness of the anode active material layer is in a range from 2 μm to 80 μm. A height of the plurality of convex portions is in a range from 0.1 μm to 20 μm.

In other features, the anode active material layer is planar and includes a plurality of concave portions. A thickness of the anode active material layer is in a range from 2 μm to 80 μm. A depth of the plurality of concave portions is in a range from 0.1 μm to 20 μm.

In other features, the cathode active material layer includes cathode active material selected from a group consisting of a rock salt layered oxide, a spinel, a polyanion cathode, an olivine cathode, a lithium transition-metal oxide, a surface-coated cathode material, a doped cathode material, and combinations thereof. The cathode active material layer includes a solid electrolyte selected from a group consisting of sulfide-based solid electrolyte, a halide-based solid electrolyte, and a hydride-based solid electrolyte. A porosity of the anode active material layer is in a range from 5% to 70%.

A battery cell includes C cathode electrodes including a cathode active material layer arranged on a cathode current collector, A anode electrodes including an anode active material layer arranged on an anode current collector, and S separators, where A, C and S are integers greater than one. The anode active material layer comprises silicon and titanium that are co-sputtered, the silicon comprises 30 at % to 99.5 at % of the anode active material layer, and the titanium comprises 0.5 at % to 70 at % of the anode active material layer.

In other features, the anode active material layer includes a plurality of columns having a height in a range from 1.0 μm to 80 μm and a width in a range from 1.0 μm to 80 μm. The anode active material layer is planar and has a thickness in a range from 2 μm to 80 μm.

In other features, the anode active material layer is planar and includes a plurality of convex portions. A thickness of the anode active material layer is in a range from 2 μm to 80 μm. A height of the plurality of convex portions is in a range from 0.1 μm to 20 μm.

In other features, the anode active material layer is planar and includes a plurality of concave portions. A thickness of the anode active material layer is in a range from 2 μm to 80 μm. A depth of the plurality of concave portions is in a range from 0.1 μm to 20 μm.

In other features, the cathode active material layer includes cathode active material selected from a group consisting of a rock salt layered oxide, a spinel, a polyanion cathode, an olivine cathode, a lithium transition-metal oxide, a surface-coated cathode material, a doped cathode material, and combinations thereof. The cathode active material layer includes a solid electrolyte selected from a group consisting of sulfide-based solid electrolyte, a halide-based solid electrolyte, and a hydride-based solid electrolyte.

In other features, a porosity of the anode active material layer is in a range from 5% to 70%.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes including a co-sputtered Si-metal layer, and separators arranged in a battery cell enclosure according to the present disclosure;

FIG. 2 is a more detailed side cross sectional view of an example of a battery cell including cathode electrodes, anode electrodes including a co-sputtered Si-metal layer, and separators arranged in a battery cell enclosure according to the present disclosure;

FIG. 3A is a side view of an anode electrode including columnar, co-sputtered Si-metal active material according to the present disclosure;

FIG. 3B is a perspective view illustrating co-sputtered Si-metal column according to the present disclosure;

FIGS. 4A to 4C are side cross sectional views of examples of anode electrodes including a co-sputtered Si-metal layer according to the present disclosure;

FIGS. 5A to 5C are side cross sectional views of examples of anode electrodes including a porous co-sputtered Si-metal layer according to the present disclosure;

FIGS. 6A to 6C are functional block diagrams of a DC magnetron for co-sputtering of a Si-metal layer according to the present disclosure;

FIGS. 7A and 7B are graphs illustrating XRD profiles and Raman spectrum, respectively, for a Si layer and a co-sputtered Si—Ti layer according to the present disclosure; and

FIGS. 8A and 8B are graphs illustrating capacity and capacity retention % as a function of cycles for a Si layer and a Si—Ti layer according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Silicon has emerged as a promising alternative to graphite-based anode electrodes for all-solid-state battery (ASSB) cells due to its environmental benignity, reasonable electrochemical potential (˜0.3 V vs Li/Li⁺), and high theoretical capacity (e.g., 4200 mAh/g for Li₄·4Si). However, Si anode electrodes have large volumetric expansion (>300%) with high mechanical stress during charging, which causes cracking and/or pulverization of the Si anode electrodes and then rapid capacity fading during cycling. In addition, the rate performance of solid-state Si anode also needs to be enhanced.

An advanced silicon anode electrode for ASSB cells includes a co-sputtered silicon-metal layer (e.g., a silicon-titanium (Si—Ti) layer). The metal comprises titanium (Ti). Zirconium (Zr), other Group 4 (IVb) metals, vanadium (V), niobium (Nb), and other Group 5 (Vb) metals. The metal atoms in the Si-metal layer function as an atomic binding agent to grasp Si atoms together during lithiation and stabilize the Si structure. The metal atoms reduce Si volumetric expansion and improve the cycle life of the ASSB cells. The metal atoms also increase electrical conductivity of the Si anode electrode and enhance power capability.

Referring now to FIG. 1, a battery cell 10 includes C cathode electrodes 20, A anode electrodes 40 including the co-sputtered Si-metal layer, and S separators 32 arranged in a predetermined sequence in a battery cell stack 12 located in an enclosure 50, where C, S and A are integers greater than zero. The C cathode electrodes 20-1, 20-2, . . . , and 20-C include cathode active material layers 24 arranged on one or both sides of cathode current collectors 26.

The A anode electrodes 40-1, 40-2, . . . , and 40-A include anode active material layers 42 arranged on one or both sides of the anode current collectors 46. The anode active material of the A anode electrodes 40-1, 40-2, . . . , and 40-A include the co-sputtered Si-metal layer as will be described further below.

In some examples, the cathode active material layers 24 are electrodes that are arranged adjacent to (or attached to) the cathode current collectors 26, respectively. In some examples, the cathode active material layers 24 comprise coatings including one or more active materials, one or more conductive fillers/additives, and/or one or more binder materials that are applied to the current collectors.

In some examples, the cathode current collectors 26 and/or the anode current collectors 46 comprise metal foil, metal mesh, and/or expanded metal. In some examples, the cathode current collectors 26 are made of one or more materials selected from a group consisting of aluminum, stainless steel, brass, bronze, zinc, and/or alloys thereof. In some examples, the anode current collectors 46 are made of one or more materials selected from a group consisting of copper or stainless steel. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

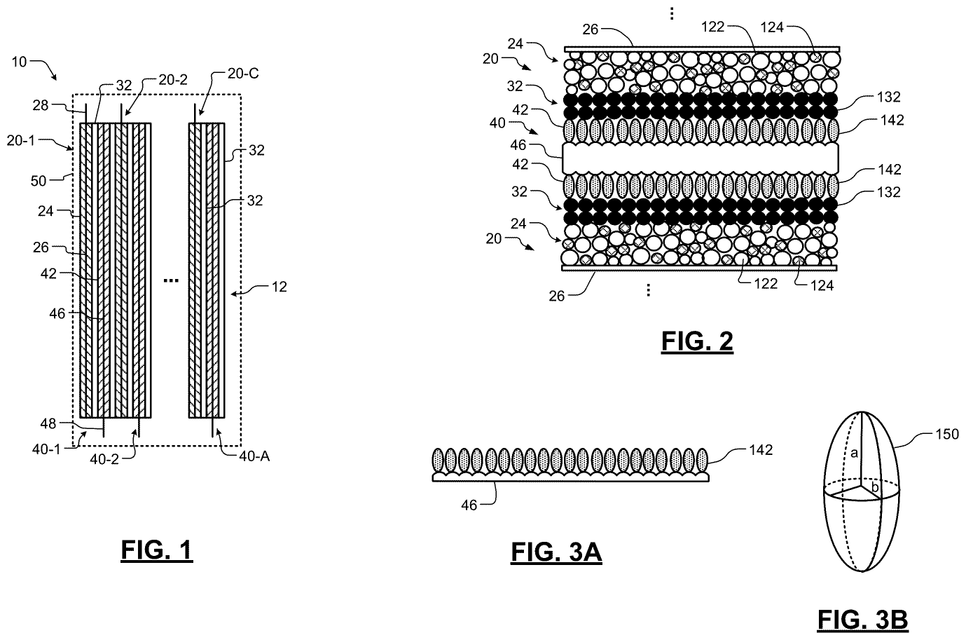

Referring now to FIG. 2, the battery cell 10 is shown in more detail. The cathode active material layer 24 includes cathode active material 122 and solid electrolyte 124. The anode active material layer 42 includes co-sputtered Si-metal layer 142. The S separators 32 include solid electrolyte 132.

Referring now to FIGS. 3A and 3B, the co-sputtered Si-metal layer 142 can include Si-metal columns. In some examples, the columns have a first dimension a (where 2*a corresponds to vertical height) in a range from 0.5 μm to 40 μm (e.g., 4.0 μm) and a second dimension b (where 2*b corresponds to lateral width) in a range from 0.5 μm to 40 μm (e.g., 4.0 μm).

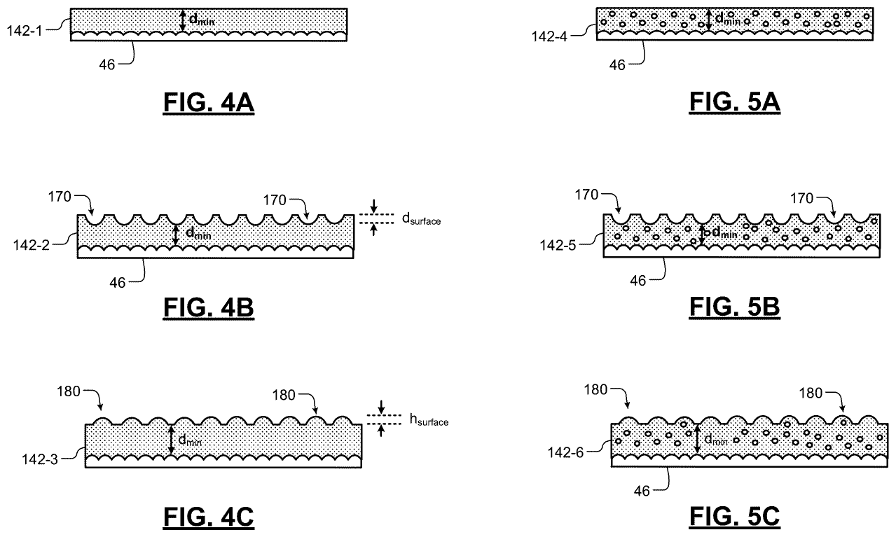

Referring now to FIGS. 4A to 4C, various examples of the co-sputtered Si-metal layer is shown. In FIG. 4A, a flat surface 142-1 is dense and includes a planar, co-sputtered Si-metal layer deposited on the anode current collector 46. A dimension dₘᵢₙ (from a top surface of the anode current collector 46 to a top surface thereof) is in a range from 2 μm to 80 μm.

In FIG. 4B, a flat surface 142-2 is dense and includes a co-sputtered Si-metal layer with concave portions 170 on a top surface thereof. A dimension dₘᵢₙ (from a top surface of the anode current collector 46 to a bottom of the concave portions 170) is in a range from 2 μm to 80 μm and a dimension d_{surface} corresponding to a depth of the concave portions is in a range from 0.1 μm to 20 μm.

In FIG. 4C, a flat surface 142-3 is dense and includes a co-sputtered Si-metal layer with convex portions 180. A dimension dₘᵢₙ (from a top surface of the anode current collector 46 to a top surface thereof (excluding the convex portions 180)) is in a range from 2 μm to 80 μm and a dimension d_{surface} corresponding to a depth of the convex portions is in a range from 0.1 μm to 20 μm. The flat, concave, or convex surfaces are created by controlling surface roughness R_{z} of the anode current collector 46 and one or more PVD process parameters.

Referring now to FIGS. 5A to 5C, various examples of porous co-sputtered Si-metal layer is shown. In FIG. 5A, a flat surface 142-4 is porous and includes a co-sputtered Si-metal layer deposited on the anode current collector 46. A dimension dₘᵢₙ is in a range from 2 μm to 80 μm.

In FIG. 5B, a flat surface 142-5 is porous and includes a co-sputtered Si-metal layer with concave portions 170. A dimension dₘᵢₙ is in a range from 2 μm to 80 μm and a dimension d_{surface} corresponding to a depth of the concave portions is in a range from 0.1 μm to 20 μm.

In FIG. 5C, a flat surface 142-6 is porous and includes a co-sputtered Si-metal layer with convex portions 180. A dimension dₘᵢₙ is in a range from 2 μm to 80 μm and a dimension d_{surface} corresponding to a depth of the convex portions is in a range from 0.1 μm to 20 μm. The flat, concave, or convex surfaces and/or porosity are created by controlling surface roughness R_{z} of the anode current collector 46 and one or more PVD process parameters. In some examples, the porosity is in a range from 5% to 70%. In some examples, the metal comprises titanium and the Si—Ti layer includes 30 to 99.5 at % (e.g., 84.4 at %) Si and 0.5 to 70 at % (e.g., 15.6 at %) Ti. Areal capacity is in a range from 0.5 to 20 mAh/cm² (e.g., 3 to 10 mAh/cm²).

In some examples, a surface of the anode current collector 46 is roughened to strengthen adhesion with Si (or a low roughness surface). In some examples, the anode current collector 46 has a thickness in a range from 4 μm to 30 μm. In some examples, the anode current collector 46 is approximately flat (R_{z} less than 2 μm). In other examples, the surface roughness R_{z} is in a range from 2 to 12 μm. In some examples, the anode current collector 46 comprises copper, stainless steel, nickel, iron, titanium. In some examples, the anode current collector 46 includes copper having a thickness of 16 μm and a surface roughness R_{z} of 8 μm.

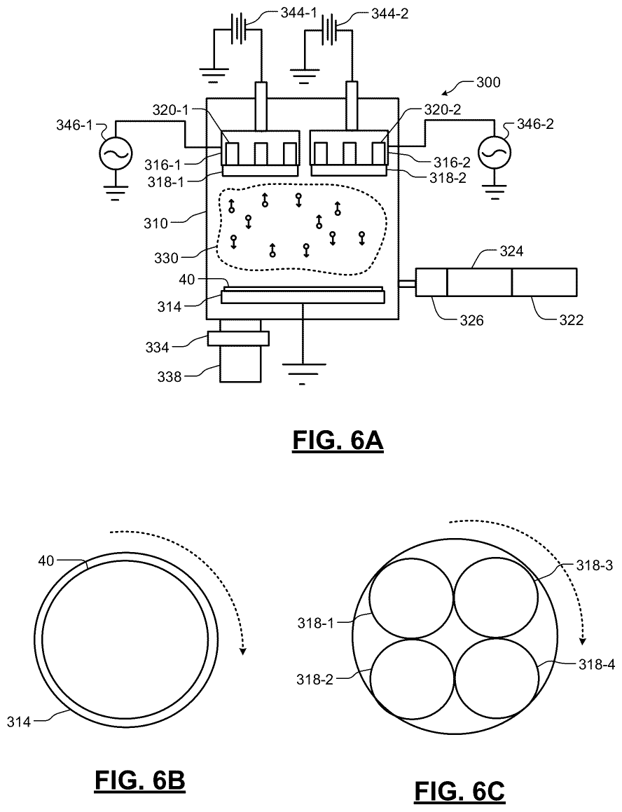

Referring now to FIGS. 6A to 6C are functional block diagrams of a magnetron for co-sputtering of a Si-metal layer. FIG. 6A shows a DC magnetron sputtering device 300 including both Si and metal targets for co-sputtering the Si-metal layer on the anode current collector 46. The anode current collector 46 is arranged on a substrate support 314 in a processing chamber 310. Magnetron cathodes 316-1, 316-2, . . . (also referred to as magnetron cathodes 316) include sets of magnets 320-1, 320-2, . . . (also referred to as magnets 320) and Si or the metal targets 318-1, 318-2, . . . (also referred to as targets 318) arranged above the substrate support 314.

During deposition, a process gas mixture such as argon (Ar) from a gas source 322 is introduced into the processing chamber 310 while AC and/or DC power are supplied. In some examples, a mass flow controller 324 and a valve 326 are used to meter the process gas from the gas source 322. A throttle valve 334 and/or pump 338 may be used to control pressure within the processing chamber 310 and/or to evacuate reactants from the processing chamber 310. DC sources 344-1, 344-2, . . . (also referred to as DC sources 344) supply DC voltage to the magnetron cathodes 316. An AC source 346 supplies AC voltage to the magnetron cathodes 316. In some examples, the anode current collector 46 and the substrate support 314 are rotated during co-sputtering (as shown in FIG. 6B) to provide more uniform distribution of sputtered material on the anode current collector 46. In other examples, the targets 318 are rotated relative to the anode current collector 46 and the substrate support 314 (as shown in FIG. 6C).

During deposition, target material (Si and the metal) is ejected from the targets 318 and deposited on the anode current collector 46. Material is also sputtered from an exposed surface of the anode current collector 46. In some examples, the Si-metal layer is deposited using pulsed DC magnetron sputtering in an argon (Ar) atmosphere.

In some examples, the DC source 344 supplies DC voltage in a range from 200V to 800V (e.g., 450V). In some examples, cathode power from the AC source 346 is supplied to the Si targets is in a range from 2 to 30 KW (e.g., 6 kW) at a frequency in a range from 20 kHz to 200 kHz. In some examples, cathode power from the AC source 346 is supplied to the metal targets is in a range from 0.1 to 30 KW (e.g., 0.7KW) at a frequency in a range from 20 kHz to 200 kHz.

Depositing the Si-metal layer is solvent-free as compared to wet processes compared to wet-coating sulfide-based electrodes (there is no need for H₂O/O₂ control). In addition, the anode electrodes have improved mechanical flexibility.

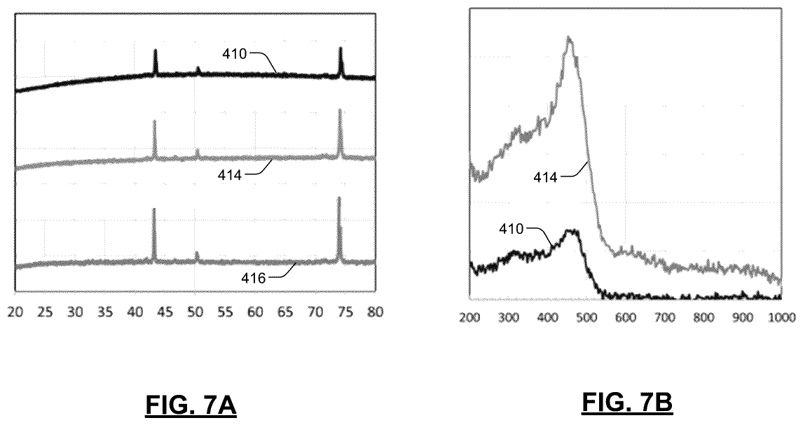

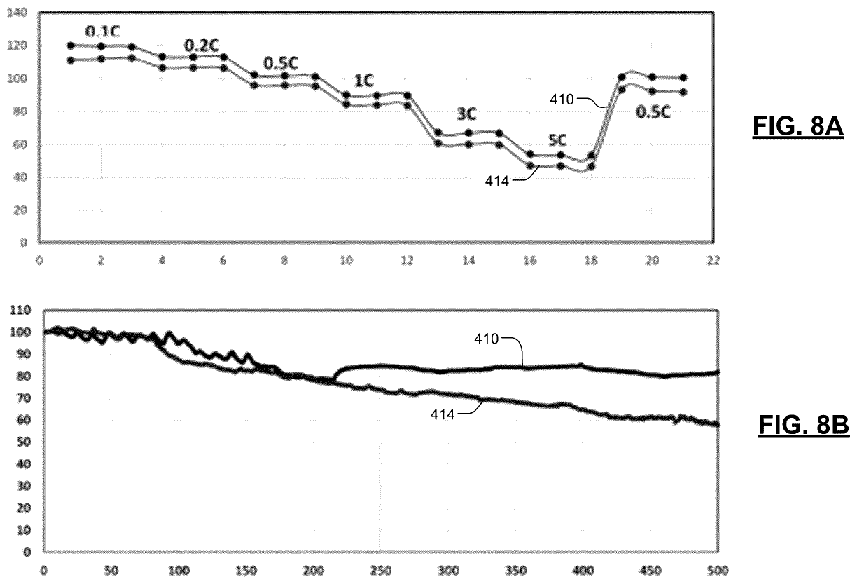

Referring now to FIGS. 7A and 7B, graphs illustrating x-ray diffraction (XRD) profiles and Raman spectrum, respectively, for silicon layer (at 414), Si—Ti layer (at 410), and a roughened current collector (at 416). In FIG. 7A, the XRD profile shows the as-deposited Si layer and Si—Ti layer are amorphous with no XRD diffraction peaks corresponding to Si or Ti. In FIG. 7B, the peak at 465 cm⁻¹ can be assigned to the transverse optical (TO) mode of amorphous-Si (a-Si). The addition of Ti into Si matrix can reduce the a-Si peak intensity, which may be due to the decreasing number of Si—Si bonds with increasing Ti content.

Referring now to FIGS. 8A and 8B, capacity and capacity retention % as a function of cycles for the silicon layer 414 and the Si—Ti layer 410 are shown at 25° C. rate performance and 25° C. cycle performance, respectively. The anode electrode loading was 3.5 mAh/cm² and the cathode loading was 1.41.mAh/cm². The Ti-introduced Si layer at 410 delivers enhanced rate capability and prolonged cycle life due to the introduction of Ti.

In some examples, the cathode active material layer of the cathode electrodes comprises cathode active material and optionally includes one or more of a solid electrolyte, a conductive additive, and/or a binder. In some examples, the cathode active material comprises 30 wt % to 98 wt %. If used, the solid electrolyte comprises 5 wt % to 50 wt %. If used, the conductive additive comprises 0.1 wt % to 30 wt %. If used, the binder comprises 0.1 wt % to 20 wt %. In some examples, the cathode electrode has a thickness in a range from 10 μm to 500 μm (e.g., 40 μm).

In some examples, the cathode active material is selected from a group consisting of rock salt layered oxides, spinel, polyanion cathode, olivine cathode, other lithium transition-metal oxides, surface-coated and/or doped cathode materials, and low voltage cathode materials.

Examples of the rock salt layered oxides include LiCoO₂, LiNiₓMn_{y}Co_{1-x-y}O₂, LiNiₓMn_{y}Al_{1-x-y}O₂, LiNiₓMn₁₋ₓO₂, Li₁₊ₓMO₂. Examples of spinel include LiMn₂O₄, LiNi_{0.5}Mn_{1.5}O₄. Examples of polyanion cathode include LiV₂(PO₄)₃. Examples of olivine include LiFePO₄ and LiMnₓFe₁₋ₓPO₄. Examples of surface-coated and/or doped cathode materials include LiNbO₃-coated LiMn₂O₄, Li₂ZrO₃ or Li₃PO₄-coated LiNiₓMn_{y}Co_{1-x-y}O₂, and Al-doped LiMn₂O₄. Examples of low voltage cathode material include lithiated metal oxide/sulfide (e.g., LiTiS₂), lithium sulfide, and sulfur.

In some examples, the solid electrolyte is selected from a group consisting of a sulfide-based solid electrolyte, a halide-based solid electrolyte, and a hydride-based solid electrolyte. In some examples, the sulfide-based solid electrolyte is selected from a group consisting of pseudobinary sulfide, pseudoternary sulfide, and pseudoquaternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX(X═F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}AS_{0.166}S₄), Li₂S—P₂S₅—Al₂S₃ system, Li₂S—LiX—SiS₂ (X═F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of halide-based solid electrolyte include Li₃YCl₆, Li₃InCl₆, Li₃YBr₆, LiI, Li₂CdCl₄, Li₂MgCl₄, Li₂Cdl₄, Li₂Znl₄, Li₃OCl. Examples of hydride-based solid electrolyte include LiBH₄, LiBH₄—LiX(X═Cl, Br or I), LiNH₂, Li₂NH, LiBH₄—LINH₂, Li₃AlH₆. In other examples, the solid electrolyte comprises an electrolyte having low grain-boundary resistance.

In some examples, the conductive additive is selected from a group consisting of carbon black, graphite, graphene, graphene oxide, Super P, acetylene black, carbon nanofibers, carbon nanotubes, and other electronically conductive additives.

In some examples, the binder comprises polytetrafluoroethylene (PTFE), sodium carboxymethyl cellulose (CMG), styrene butadiene rubber (SBR), poly(vinylidene fluoride) (PVDF), nitrile butadiene rubber (NBR), styrene ethylene butylene styrene copolymer (SEBS), styrene butadiene styrene copolymer (SBS), or other suitable binder.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
C cathode electrodes including a cathode active material layer arranged on a cathode current collector;
A anode electrodes including an anode active material layer arranged on an anode current collector; and
S separators, where A, C and S are integers greater than one,
wherein the anode active material layer comprises silicon and a metal that are co-sputtered, wherein the metal is different than the silicon.

2. The battery cell of claim 1, wherein the metal is selected from a group consisting of titanium (Ti), zirconium (Zr), a Group 4 (IVb) metal, vanadium (V), niobium (Nb), and a Group 5 (Vb) metal.

3. The battery cell of claim 1, wherein:
the metal comprises titanium,
the silicon comprises 30 at % to 99.5 at % of the anode active material layer, and
the titanium comprises 0.5 at % to 70 at % of the anode active material layer.

4. The battery cell of claim 3, wherein the anode current collector has a surface roughness in a range from 2 μm to 12 μm.

5. The battery cell of claim 3, wherein the anode active material layer includes a plurality of columns.

6. The battery cell of claim 5, wherein the plurality of columns have a height in a range from 1.0 μm to 80 μm and width in a range from 1.0 μm to 80 μm.

7. The battery cell of claim 1, wherein the anode active material layer is planar and has a thickness in a range from 2 μm to 80 μm.

8. The battery cell of claim 1, wherein the anode active material layer is planar and includes a plurality of convex portions.

9. The battery cell of claim 8, wherein:
a thickness of the anode active material layer is in a range from 2 μm to 80 μm; and
a height of the plurality of convex portions is in a range from 0.1 μm to 20 μm.

10. The battery cell of claim 1, wherein the anode active material layer is planar and includes a plurality of concave portions.

11. The battery cell of claim 10, wherein:
a thickness of the anode active material layer is in a range from 2 μm to 80 μm; and
a depth of the plurality of concave portions is in a range from 0.1 μm to 20 μm.

12. The battery cell of claim 1, wherein:
the cathode active material layer includes cathode active material selected from a group consisting of a rock salt layered oxide, a spinel, a polyanion cathode, an olivine cathode, a lithium transition-metal oxide, a surface-coated cathode material, a doped cathode material, and combinations thereof, and
the cathode active material layer includes a solid electrolyte selected from a group consisting of sulfide-based solid electrolyte, a halide-based solid electrolyte, and a hydride-based solid electrolyte.

13. The battery cell of claim 12, wherein a porosity of the anode active material layer is in a range from 5% to 70%.

14. A battery cell comprising:
C cathode electrodes including a cathode active material layer arranged on a cathode current collector;
A anode electrodes including an anode active material layer arranged on an anode current collector; and
S separators, where A, C and S are integers greater than one,
wherein the anode active material layer comprises silicon and titanium that are co-sputtered, the silicon comprises 30 at % to 99.5 at % of the anode active material layer, and the titanium comprises 0.5 at % to 70 at % of the anode active material layer.

15. The battery cell of claim 14, wherein the anode active material layer includes a plurality of columns having a height in a range from 1.0 μm to 80 μm and a width in a range from 1.0 μm to 80 μm.

16. The battery cell of claim 14, wherein the anode active material layer is planar and has a thickness in a range from 2 μm to 80 μm.

17. The battery cell of claim 14, wherein:
the anode active material layer is planar and includes a plurality of convex portions,
a thickness of the anode active material layer is in a range from 2 μm to 80 μm; and
a height of the plurality of convex portions is in a range from 0.1 μm to 20 μm.

18. The battery cell of claim 14, wherein:
the anode active material layer is planar and includes a plurality of concave portions,
a thickness of the anode active material layer is in a range from 2 μm to 80 μm; and
a depth of the plurality of concave portions is in a range from 0.1 μm to 20 μm.

19. The battery cell of claim 14, wherein:
the cathode active material layer includes cathode active material selected from a group consisting of a rock salt layered oxide, a spinel, a polyanion cathode, an olivine cathode, a lithium transition-metal oxide, a surface-coated cathode material, a doped cathode material, and combinations thereof, and
the cathode active material layer includes a solid electrolyte selected from a group consisting of sulfide-based solid electrolyte, a halide-based solid electrolyte, and a hydride-based solid electrolyte.

20. The battery cell of claim 14, wherein a porosity of the anode active material layer is in a range from 5% to 70%.
